(19) United States
(12) Patent Application Publication
(10) Pub. No.: US 2014/0162781 A1
(43) Pub. Date: Jun. 12, 2014

(54) SYSTEM AND METHOD FOR BUILDING IN GROUPS

(71) Applicant: SONY ONLINE ENTERTAINMENT LLC, SAN DIEGO, CA (US)

(72) Inventors: Jeffrey Butler, Poway, CA (US); Darrin McPherson, Oceanside, CA (US); Terry Michaels, Fallbrook, CA (US)

(73) Assignee: SONY ONLINE ENTRTAINMENT LLC, San Diego, CA (US)

(21) Appl. No.: 14/094,479

(22) Filed: Dec. 2, 2013

Related U.S. Application Data
(60) Provisional application No. 61/734,292, filed on Dec. 6, 2012.

(51) Int. Cl. A63F 13/30

(52) U.S. Cl. CPC A63F 13/12
USPC 463/31

(57) ABSTRACT

The disclosed systems and methods provide ways to coordinate group efforts in constructing digital objects. Multiple players with different skills and availability may be enabled to work together to complete various desired digital objects. Participants in the projects can join in numerous ways, including by responding to open requests or by being identified through profiles and social network connections.

### CROSS-REFERENCE TO RELATED APPLICATIONS

This patent application claims benefit of priority of U.S. Provisional Patent Application Ser. No. 61/734,292, filed Dec. 6, 2012, entitled “Building in Groups”, owned by the assignee of the present invention and herein incorporated by reference in its entirety.

### FIELD OF THE INVENTION

This invention is in the field of video games, and more particularly in the field of organizing groups of players to accomplish tasks within a multiplayer game.

### BACKGROUND

Some digital objects are formed from multiple components. Building each component can be time-consuming and expensive in terms of the resources required to build the components, thus it is often useful to have people work together to build the components. However, it can be difficult to find people to join such projects.

An exemplary situation is shown in FIG. 1, which shows a flowchart of a prior art method 10. A user may desire the construction of a digital object, the digital object requiring a construction project for its completion (step 12). The user may be aware of friends who have particular skills or materials needed to complete the object, and so the user may ask the friends to make such components or provide such skills (step 14). The user then employs the made components and creates the digital object (step 16).

For example, in the field of multiplayer online games, and in particular in crafting efforts therein, a user may desire an item that requires blacksmithing skills, but the user (or user's character) may not have such skills themselves. In the same way, the item may require particular metals for its construction, but the user may not have mining skills to get such metals. The user may inquire of their friends or guild mates to obtain such skills or components, but if such contacts do not have the required skills or components, or are unable or unwilling to make them, or for that matter are simply off-line, the user has no way of creating the desired item.

### SUMMARY

The disclosed systems and methods provide structures and interfaces to coordinate group efforts in constructing digital objects. Multiple players with different skills and availabilities may be enabled to work together to complete various digital objects. Participants in the project can join in numerous ways, including by responding to open requests or by being identified through profiles or social network connections.

In one aspect, the invention is directed towards a method of organizing a plurality of builders to build an assembly, including: receiving a definition from a project creator, the definition pertaining to an assembly; from the received definition, determining a plurality of resources required to build the assembly; using the determined resources, determining a plurality of builders having one or more of the plurality of resources required to build the assembly, or capable of making one or more of the plurality of resources required to build the assembly; and storing the determined plurality of builders, whereby the project creator may become aware of the determined plurality.

Implementations of the invention may include one or more of the following. The assembly may be a virtual assembly, and the determining a plurality of builders capable of making one or more of the plurality of resources may further include determining a plurality of builders associated with player characters, where the player characters have one or more resources required to build the virtual assembly, or are capable of making one or more of the plurality of resources required to build the virtual assembly, where a player character is capable of making one or more of the plurality if the player character is associated with skills required to make the one or more of the plurality. The receiving a definition may include receiving a custom construction plan including a set of proposed resources or components or both, and the determining a plurality of resources may include matching proposed resources or components with certain of a set of available resources. The receiving a definition may also include receiving requirements of a desired assembly, and the determining a plurality of resources may include determining a plurality of resources necessary to meet the requirements. The receiving a definition may further include receiving a selection of an object from a menu, and the determining a plurality of resources may include determining a plurality of resources necessary to create an assembly corresponding to the selected object. The receiving a definition may further include receiving a customization option of the object, and the determining a plurality of resources may further include determining a plurality of resources necessary to create or perform a customization option of the assembly to correspond to the customization option of the object. The assembly may be a CG object or a software application. The method may further include filtering the determined builders based on one or more criteria, where the criteria include one or more selected from the group consisting of: rating, skills, reputation, social network status with respect to the project creator, average online time, faction, and server. The determining a plurality of builders may include analyzing a contacts list of the project creator and player characters associated therewith, a social networking friends list of the project creator and player characters associated therewith, a buddy list of the project creator and player characters associated therewith, a members list of a guild associated with the project creator or with a player character controlled by the project creator, profiles of members of an online community and player characters associated therewith, or profiles of a group or company of builders indicating a desired for cooperative building. One of the plurality of resources may be a custom component, and the method may further include displaying a request for proposals for the custom component, along with at least one requirement of the custom component. Resources may be one or more selected from the group consisting of: components, materials, subcomponents required to build components, materials required to build components or subcomponents, services required to obtain components or subcomponents or materials, services required to make components or subcomponents or materials, or services required to construct at least a portion of an assembly from components or materials or both.

In another aspect, the invention is directed towards a non-transitory computer readable medium, including instructions for causing a computing environment to perform the above or below methods.

In another aspect, the invention is directed towards a method of organizing a plurality of builders to build an assembly, including: receiving a definition from a project creator, the definition pertaining to an assembly; from the received definition, determining a plurality of resources required to build the assembly; publishing a list of one or more of the plurality of resources in a location accessible to a community, and receiving responses to the published list from builders indicating interest in providing one or more of the plurality of resources.

Implementations of the invention may include one or more of the following. The invention may further include displaying builders from which responses have been received, and may further include filtering the displayed based on one or more criteria, where the criteria include one or more selected from the group consisting of: rating, skills, reputation, social network status with respect to the project creator, average online time, faction, and server.

In yet a further aspect, the invention is directed towards a method of organizing a plurality of builders to build an assembly, including: receiving a definition from a project creator, the definition pertaining to an assembly; from the received definition, determining a plurality of resources required to build the assembly; and matching one or more builders indicating interest in building with one or more of the plurality of resources corresponding to an assembly.

Implementations of the invention may include one or more of the following. The method may further include transmitting a notification to a builder indicating that the builder is hired to provide the one or more of the plurality of resources. The method may further include automatically matching builders to the assembly, according to which builder first indicated interest in one or more of the plurality of resources. The method may further include filtering the builders to be matched based on one or more criteria, where the criteria include one or more selected from the group consisting of: rating, skills, reputation, social network status with respect to the project creator, average online time, faction, and server.

In yet another aspect, the invention is directed towards a method of building an assembly using a plurality of builders, the assembly having a definition provided by a project creator, the assembly having multiple components, including: receiving a finished component from a builder, and installing the finished component in an assembly according to a definition; if a finished component requires a specialized installation, determining one or more builders capable of performing the specialized installation, and sending a request to the determined one or more builders to perform the specialized installation; if a component requires specialized services, determining one or more builders capable of performing the specialized services, and sending a request to the determined one or more builders to perform the specialized services; and performing the installing, the specialized installations as needed, and the specialized services as needed, until all components in the assembly are installed according to the definition.

Implementations of the invention may include one or more of the following. The method may further include displaying a status indicating a state of completion of the assembly, and upon each installation, specialized installation, or service, updating the status. One or more builders may perform the specialized installation in collaboration with the project creator. The assembly may be a virtual assembly and may be associated with an online simulation, and a player character may be associated with the project creator and player characters may further be associated with respective ones of at least a subset of builders providing components or services and the group may congregate at a common virtual location within the online simulation to perform a building of the virtual assembly.

In yet a further aspect, the invention is directed towards a method for creating digital objects, including: receiving a construction request from a requesting user; creating a construction project to build a digital object, where the digital object includes multiple components; creating a component list of missing components needed to complete the digital objects; searching for users to provide the missing components; creating a builder list of users identified to provide missing components; receiving components from users; and when all the missing components have been received, building the digital object.

Implementations of the invention may include one or more of the following. The searching for users to provide missing components may include placing a component request on a marketplace service. The searching for users may also include using a matchmaking tool that compares skills required to build components and skills of available users, or may alternatively or in addition include using a social network to identify users by their relationship to the requesting user.

Advantages of the invention may include one or more of the following. Digital objects may be constructed in a highly-efficient manner. Digital objects that may otherwise be impossible or impractical to build for a single player may be constructed in an organized fashion by multiple builders. Builders may be enabled to profit from their skills and wares in an efficient and organized manner. Other advantages will be apparent from the following description, including the figures and claims.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is an exemplary flow chart of a joint building method according to the prior art.

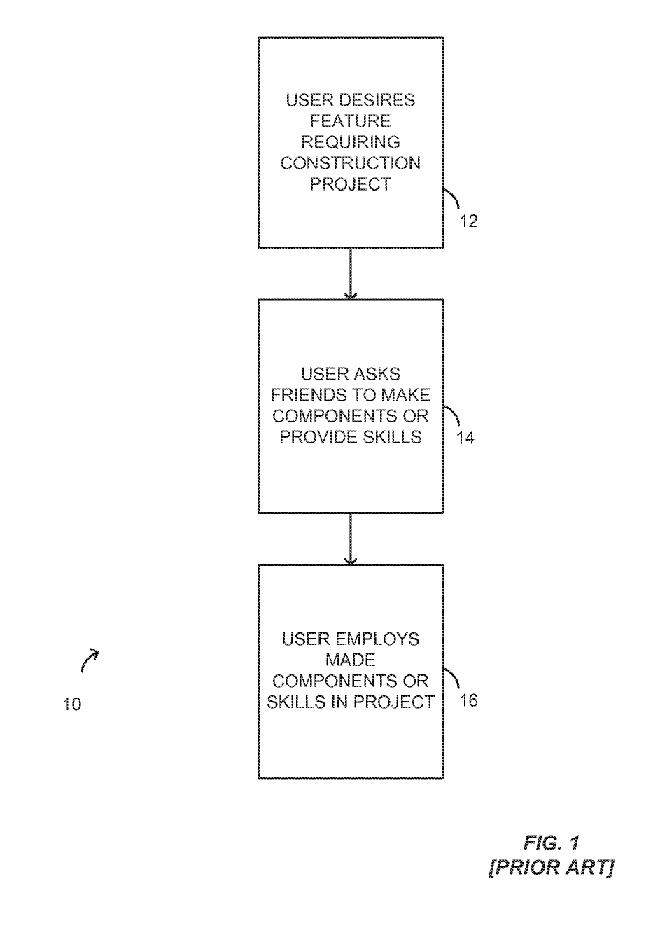

FIG. 2 is an exemplary flowchart of one implementation of a joint building method according to present principles.

FIG. 3 is a more detailed exemplary flowchart of an implementation of a joint building method according to present principles, showing in particular different types of assemblies.

FIG. 4 is another more detailed exemplary flowchart of an implementation of the joint building method according to present principles, showing in particular how the definition may be received of an assembly.

FIG. 5 is another more detailed exemplary flowchart of an implementation of the joint building method according to present principles, showing in particular different types of resources.

FIG. 6 is another more detailed exemplary flowchart of an implementation of the joint building method according to present principles, showing in particular how builders may be determined using a marketplace tool or solution.

FIG. 7 is another more detailed exemplary flowchart of an implementation of the joint building method according to present principles, showing in particular how builders may be determined using a matchmaking tool or solution.

FIG. 8 is another more detailed exemplary flowchart of an implementation of the joint building method according to present principles, showing in particular how builders may be determined using a social networking tool or solution.

FIG. 9 is another more detailed exemplary flowchart of an implementation of the joint building method according to present principles, showing in particular how ongoing construction of the digital object may proceed.

FIG. 10 is another exemplary flowchart of an implementation of a joint building method according to present principles.

FIGS. 11(A)-11(C) are other more detailed exemplary flowcharts of an implementation of the joint building method according to present principles, showing in particular how deadlines, payment, and bidding for construction of the digital object may proceed.

FIG. 12 is an exemplary computing environment in which the methods according to present principles may be implemented.

Corresponding reference characters indicate corresponding parts throughout the drawings.

### DETAILED DESCRIPTION

In systems and methods according to present principles, a computer system provides structures and interfaces to build digital objects with multiple users, such as in a game or simulation. In one implementation, a user or “project creator” uses a construction project tool to create a project to build a digital object in the game, such as a castle. The tool organizes the construction project and finds other players (“builders”) to help build the final object.

The object may have multiple components and materials, which may in turn each have multiple subcomponents or materials, and so on. For example, a castle may include stone walls which are in turn made of stone blocks which are in turn made from the raw material of stone. Depending on the implementation, some components may have subcomponents in one implementation but not in another. For example, in some implementations, stone blocks may be a purchasable item while in other implementations the same require their own construction.

The construction project tool may make a list of the necessary components and materials and may provide the list to the player. In one implementation, the tool may also identify skills needed to collect materials or build components, to help determine builders appropriate to join the project. There may also be one or more builders needed to assemble received components into larger components or assemble the final object from the provided components and materials. In such a case, the builder may receive the components or materials from the player running the project and then return the completed components, materials, or object to the player. Similarly, there may be some components that require multiple builders to work together simultaneously to complete the components (“group components”). Some components or materials may also require specialized skills for their installation in a given digital object.

It will be understood that, besides materials and components/subcomponents going from builders to the project creator, intermediaries may be employed, which provide intermediary levels of material gathering, component or subcomponents construction, or other value-added skills. Such intermediaries may be termed subcontractors, and it is understood that materials and components may go from one subcontractor to another on the way to the project creator and/or final installation.

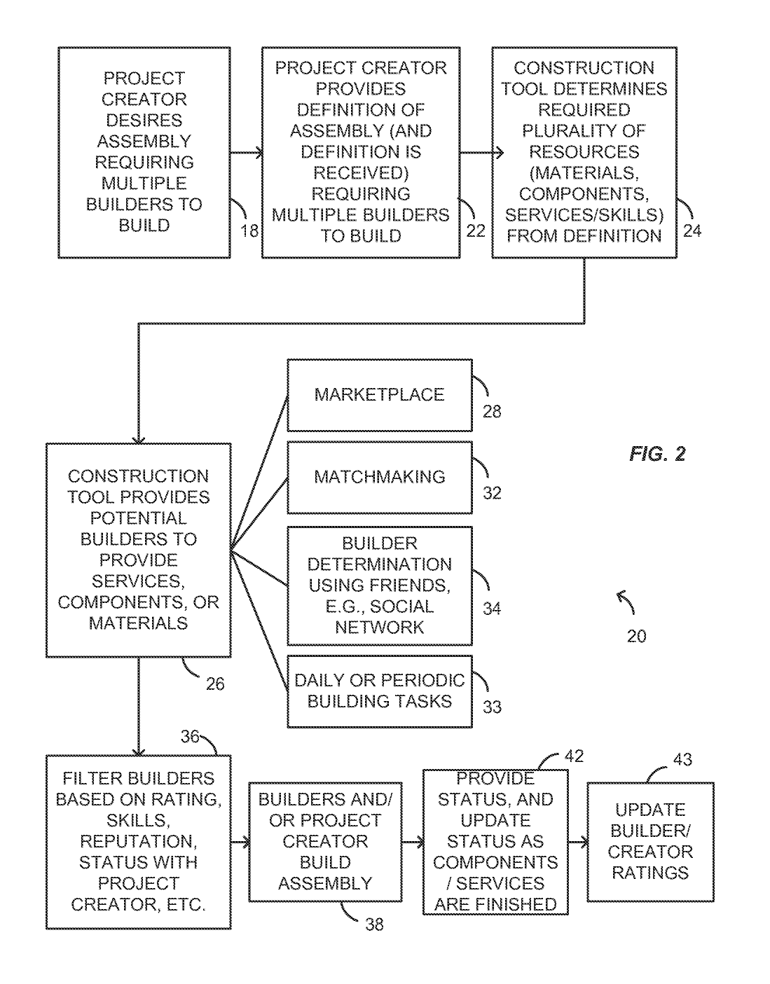

In a general method, as shown by the flowchart 20 of FIG. 2, in a first step, the project creator desires an assembly (“construction project”) requiring multiple builders to build (step 18). The project creator may be a user of an online simulation such as an online multiplayer game, or may be any other sort of user desiring completion of a project requiring multiple builders, especially of a digital object.

The assembly is generally an object such as a digital object having plural components and/or materials. Each component may include multiple subcomponents, and even certain materials may be made of sub materials. For example, a chemical substance may need multiple constituents to create a given product. Where the user is desiring construction of a digital object for a multiplayer game, the user is in many cases represented by an avatar or player character. Builders may then be other users, also represented by avatars or player characters, and in some implementations builders may be provided as nonplayer characters or NPCs.

The project creator then provides a “definition” of the assembly requiring the multiple builders to build (step 22). The definition of the assembly generally constitutes an identifier of the assembly, and can range from simple to complex, in many cases dependent on the user customization of the digital object. While assembly definitions are described in greater detail below, here it is noted that in a simple definition, a user may simply select a digital object from a list, and the construction tool may use an algorithm, a lookup table, or other means to determine all the components and materials needed to build the digital object. In a more complex definition, a user may describe a digital object to be built, in great detail, with numerous custom components and materials. It is understood that in both cases the list of required resources to accomplish the assembly may be complex, but what is required of the user may vary depending on the abilities of the construction tool.

In a next step, the construction tool then determines the plurality of resources required to complete the project according to the definition (step 24). This step too may range from simple to complex, as the user may have provided a highly-detailed definition, not requiring significant elaboration by the construction tool; or the user may have simply indicated a desired digital object, e.g., from a list, requiring the construction tool to determine all the resources needed for its construction.

The term “resources” is used herein to indicate components, including subcomponents, materials, including sub materials, as well as services and skills required to build the digital object. For example, some components or specialized installations may require highly-skilled craftspeople, i.e., craftspeople with high skill levels, while others merely require beginning craftspeople or those with low skill values. The term “services” is used to generally connote acts provided by builders, either in installing components and materials in the construction of a digital object, or in making components, subcomponents, or materials, or gathering materials or sub materials, as well as similar acts. It is noted that services often require players with certain skills, although not always. It is also noted that high skill levels or higher-rated craftspeople may not necessarily always create higher-quality components or materials, but in some implementations they may create them more consistently than a lower skilled artisan.

The construction tool then arranges or organizes builders so as to provide the resources, i.e., components, subcomponents, skills, services, and/or materials and sub materials (step 26).

The construction tool can arrange for the player to obtain builders to join the project in several ways, as illustrated by the middle section of the flowchart 20. In particular, in one way, an online marketplace or marketplace tool may be employed to find builders or to match builders with project creators (step 28). In another way, matchmaking or a matchmaking tool may be employed to find builders (step 32). In a third way, a social network or social networking tool may be employed to find builders, either where the social network is part of the online simulation or where the same is provided by a third-party or separate service. Using a marketplace or social network may provide a generally asynchronous way to find builders, while matchmaking may be more synchronous.

In a fourth way, builders may sign up to perform daily or periodic building tasks (step 33). For example, if a builder only has a short period of time, but desires to earn in-game currency by performing as a builder, short-term daily or periodic building tasks may be performed, such as painting or other repetitive tasks as it simulation may allow. These ways and tools are described in greater detail below.

A player can use one solution, or multiple solutions in parallel, to find builders to complete the project. In one implementation, the project tool updates the list of needed components and available components over time as components are completed and if necessary installed. In another implementation, NPCs are also available to hire as builders for some or all components, providing competition to player builders. As components are completed and projects finished, builders may be rated by the project creator or by other builders (step 43). Such ratings may be maintained within the simulation, within the construction project tool, or on a third-party site.

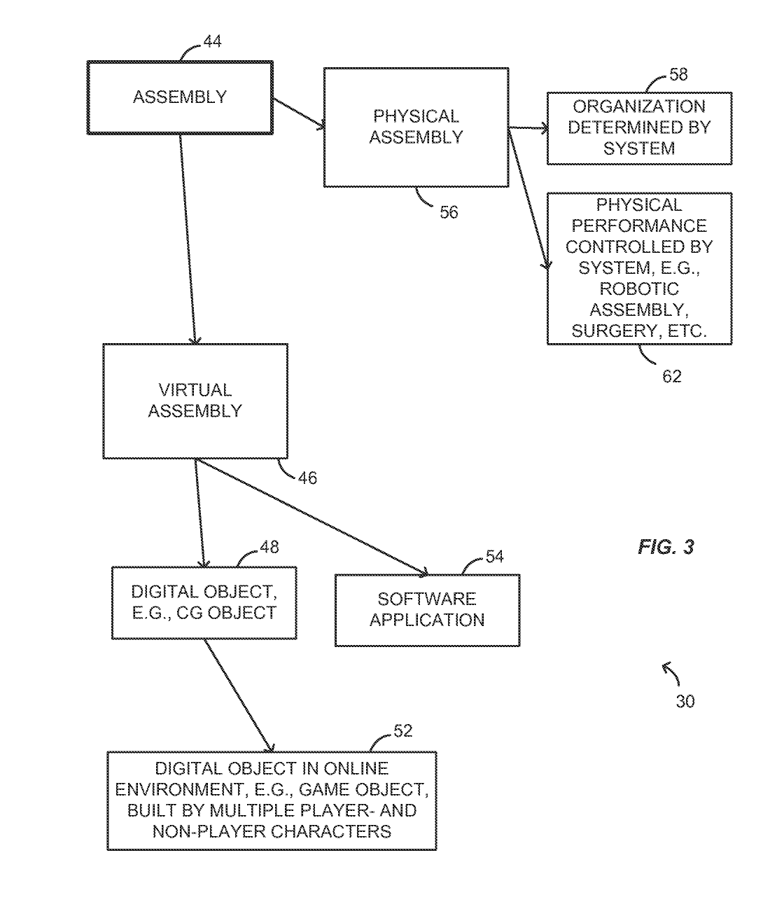

Referring to the flowchart 30 of FIG. 3, various types of assemblies 44 are illustrated. For example, an assembly may be a physical assembly 56. The systems and methods according to present principles then serve as a way to organize the construction of the physical assembly. In this way, the system is employed to determine the organization of the construction of the physical assembly (step 58), what is required for its construction, and who will build it. In some cases, physical resources such as persons may be employed to perform the actual construction using the instructions and organization of the system and method. In other cases, the physical performance of the construction of the assembly may be controlled by the system (step 62). Such would be the case where robots perform the assembly, and would also be the case where, e.g., robotic surgery or other machine-controlled functions are performed.

In most cases, however, the assembly is a virtual assembly 46. Examples of virtual assemblies 46 include a digital object such as a computer-generated object 48. Another type of virtual assembly 46 may be a software application 54. Where the virtual assembly corresponds to a digital object, the digital object may be within an online environment 52, e.g., may be a game object which may be built by multiple player and/or nonplayer characters.

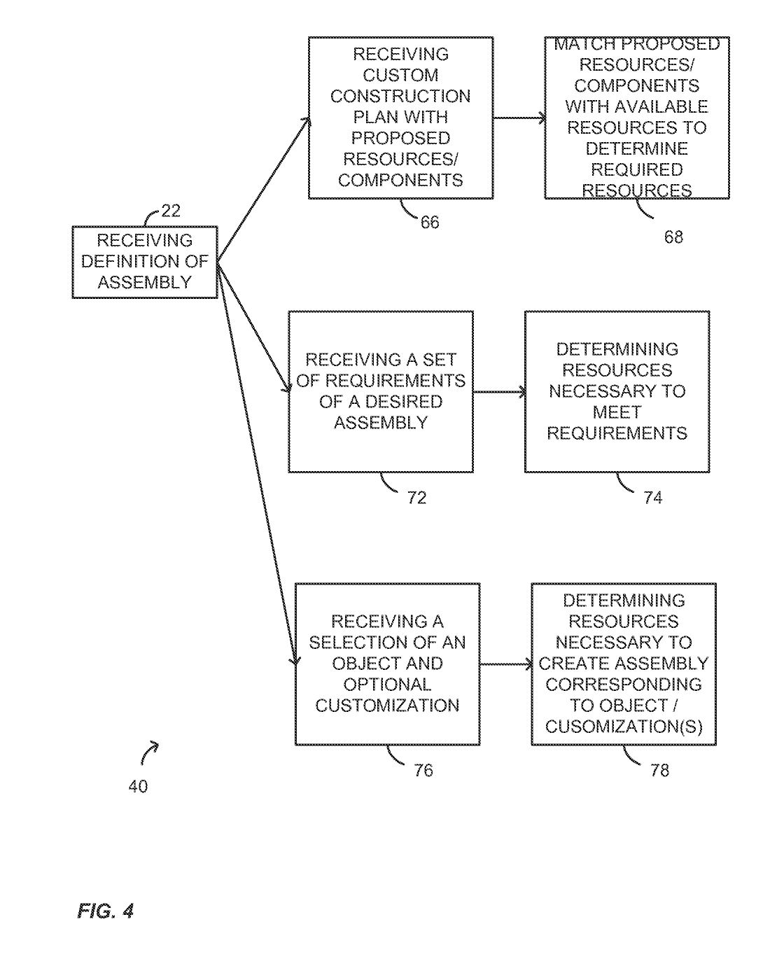

Referring to FIG. 4, a flowchart 40 is seen illustrating various exemplary ways in which the definition of an assembly may be received and used (step 22). In one exemplary way, the construction tool may receive a custom construction project where the user has already proposed various resources, components, materials, and the like (step 66). The construction tool may then match the proposed resources and components with available resources in order to determine a set of required resources necessary to complete the project, available resources being those which the project creator has in their possession or can obtain from other players, as is described below. In some cases, the user's custom construction plan will not include every necessary resource, e.g., a user may desire a particular type of stone for a castle wall but leave the rest up to the discretion of the construction tool. The user may optionally set various constraints in order to guide the discretion of the construction tool, e.g., cost constraints, a minimum level of quality, a maximum level of quality, and the like. Certain such constraints may be automatically set by, e.g., the systems knowledge of the amount of in-game currency the project creator has. Such constraints may also be employed in the below (and other) ways in which definitions of assemblies may be received and used.

In another technique, the construction tool may receive a set of requirements of a desired assembly (step 72). For example, a user may desire a castle of certain dimensions, with walls capable of withstanding a certain amount of damage over time, having at least a desired number of rooms, and so on. The construction tool may then determine the resources necessary to meet those requirements (step 74). Such determination may employ various algorithms to result in a list of resources, including employment of the constraints noted above, as well as other boundary conditions. Even within such requirements-driven assemblies, users may be empowered to select various components or materials for use in particular features.

In yet another technique, a user may select a digital object from a list, catalog, menu, or the like (step 76). The user may also select an optional customization. For example, a user may select a pre-made castle but desire that the castle have a moat. The construction tool then determines the necessary resources to create an assembly corresponding to the selected object, along with the requested customization. Algorithms and constraints as noted above may be employed, but it will be understood that, as the object is selected from a known list, a default set or sets of resources may already be known.

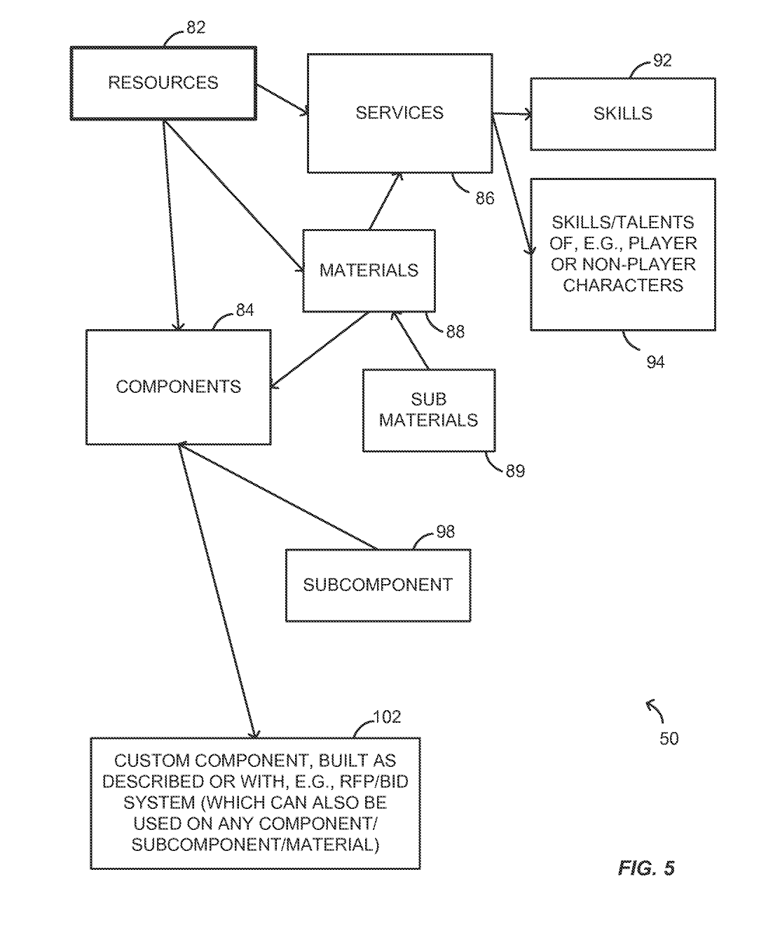

FIG. 5 is a diagram 50 illustrating various types of resources 82. Without intending to be limiting, it may be seen that resources 82 may include components 84, services 86, and materials 88.

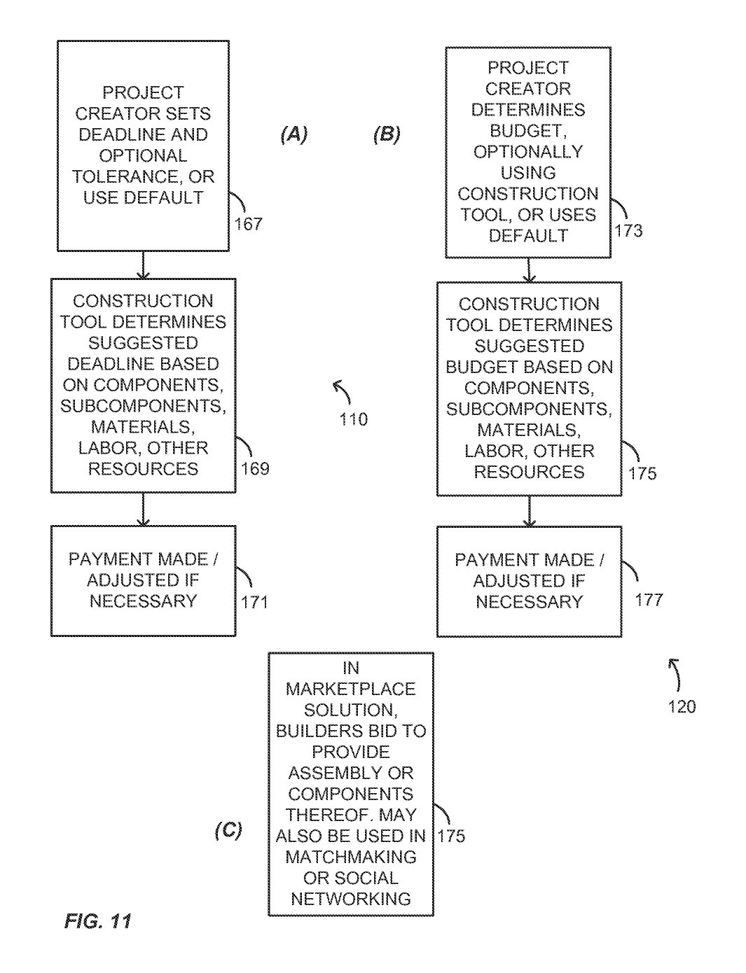

The components 84 may also include subcomponents 98, the latter referring to elements which make up components. Custom components 102 may also be employed in building projects. In custom components, the project creator can define general parameters or desired features of a custom component and the construction tool may then be employed to find builders who can build a custom component that matches the defined parameters and/or features, such as via employing bidding or a request for proposals. Additional ways in which builders may be found and incentivized to provide custom components is described in greater detail below with respect to FIG. 11.

Resources 82 may also include services 86. As noted above, services may be considered acts performed by builders or users, or their respective player characters or avatars, or even acts performed by nonplayer characters. As such, services may require certain skills 92. In the case of an online multiplayer game, skills or talents 94 of player characters or nonplayer characters may be required to provide a certain service.

Resources 82 may also include materials 88. Materials themselves may include sub materials 89, where for example several constituent elements are required to create a product material. Such constituent elements may include not only those that make up the product material but also reagents or other such materials. Materials may be required not only for components 84 but also for services 86. In the former case, for example, to create a component “stone block”, the material “stone” may be required. In the same way, to perform a service of creating a “stone block”, a “sharpening stone” material may be required to sharpen a tool by which the block is created. Numerous other examples will also be seen.

In a marketplace solution, the project creator places the project in list in a public job marketplace where others can view what is needed. Builders can agree to provide specific components or simply provide them. The construction project tool provides an interface for players to provide components to one another as part of projects. Alternatively, players can provide them through in-game mail, trading, or markets. The construction project tool tracks which components and materials have been provided and what is still needed, adjusting the marketplace listings as appropriate.

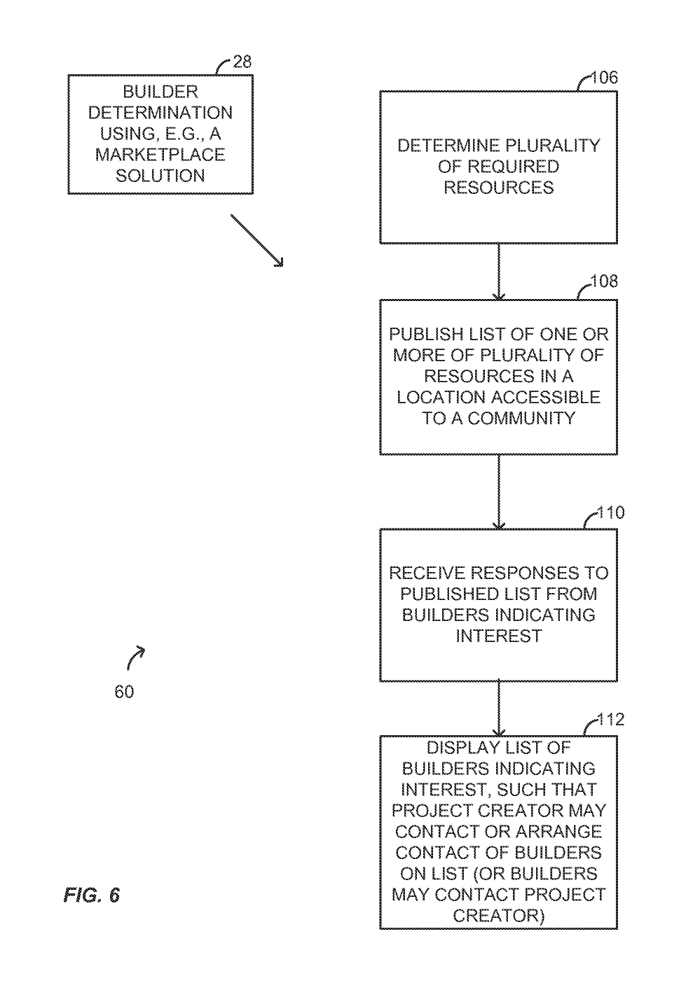

In more detail, and referring to the flowchart of FIG. 6, the builder determination using a marketplace or tool solution (step 28) is illustrated. In a first step, a plurality of required resources for a given construction project is determined (step 106). As noted previously, such may be entirely determined by the construction tool or the project creator or user may specify one or more desired resources. A list of the one or more of the plurality of resources determined is then published in a location accessible to a community (step 108). For example, a bulletin board or other such listing may be available in an online community, such as in a multiplayer game, and the same may be used to host the listing. A scope of access to the bulletin board listings may vary, from just the project creator's friends, a guild or other organization to which the project creator belongs, to the server on which the project creator plays, or the list may be open to everyone in the community. Clearly variations of this may be understood by one of ordinary skill in the art.

In one implementation, access to the list is filtered so that certain players do not see the construction project posted. It is understood that the filtering may be on the builder's side as well, so that potential builders do not see jobs for which they are unsuited. Alternatively, builders may adjust their settings so that all jobs are visible.

In a next step, the user or project creator receives responses to the published list from builders, indicating interest in taking part in the construction project (step 110). Such responses may be via in-game mail, e-mail, text, an electronic mail system associated with a network or game publisher, a communication tool within the construction project tool or marketplace tool, or any other type of electronic communication method. The responses may be filtered in the same way as noted above. Such filtering may be via any of a number of techniques as described herein, including based on the amount of time a builder is online, a builder's skill or level, ratings the builder has received for other projects, recommendations, the builder's server, the builder's time zone, the builder's faction, and the like.

In a next step, a list is displayed of builders indicating interest (step 112). In this way, the project creator may contact or arrange contact of the builders on the list. And such contact may be via any of the electronic communication methods described above. The project creator may contact potential builders directly or systems and methods according to current principles may allow for automatic contact of such builders. The construction tool may allow the user or project creator to browse the potential builders to determine who the strongest candidates are for a particular job. Techniques for providing remuneration or consideration to builders who provide components or services are discussed in greater detail below.

In a matchmaking solution, the player uses an automated matchmaking tool, e.g., “looking for builders” or “looking for work”. In this case the player opens the project in the matchmaking tool with the list of resources from the construction project tool. Other players can open the matchmaking tool and make themselves available as builders, indicating what skills they have or what components or materials they can provide. The builders may make themselves available for any projects, or can select projects from a list. In one implementation, a player simply activates the player's profile in the matchmaking tool and the matchmaking tool recognizes the capabilities and resources of the player's character from the game information for the character. The matchmaking tool then selects builders and assigns them to components and resources in the project, and also informs each builder of their tasks. The builders review their tasks and accept or decline. The matchmaking tool informs the project creator of each confirmed builder along with their tasks. The builders gather necessary materials and build their assigned components, providing the requested materials and finished components to the project creator either directly, e.g., using in-game mail or via other techniques noted above, such as by the construction project tool, before the specified deadlines. In one implementation, some or all of the builders do not know what the project is, only what their task is. In another implementation, builders may look for and join projects in groups, such as a guild, a company, or a smaller ad hoc group.

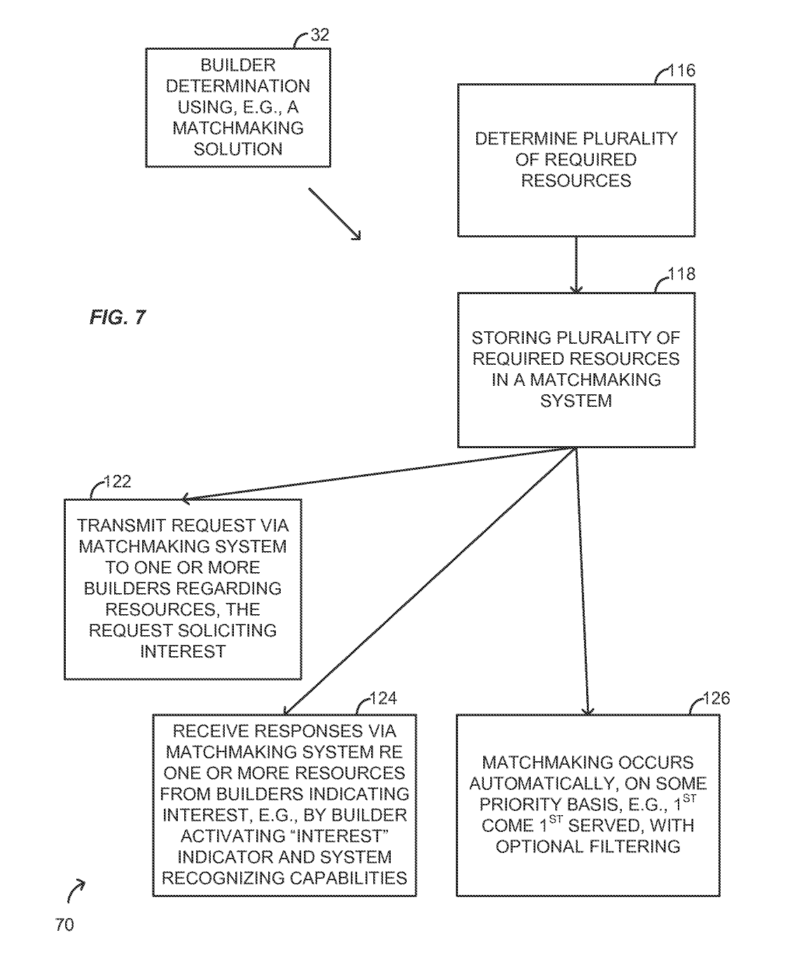

In more detail, referring to the flowchart 70 of FIG. 7 where a project creator decides to employ a matchmaking solution in builder determination (step 32), a first step is, as in the prior figure, to determine the plurality of required resources (step 116), and such may be performed in the same manner as before. In a next step, the determined plurality of required resources are stored or otherwise delivered to the matchmaking system (step 118).

Several steps may then be performed in parallel. For example, the project creator may transmit a request using the matchmaking system to one or more builders regarding resources, the requests soliciting interest from the builders in providing components, materials, services, and the like (step 122). Conversely, the project creator may receive a response from the matchmaking system regarding one or more resources from builders indicating interest in taking part in the project (step 124). For example, a builder may indicate interest and the matchmaking system may then indicate the interest to the project creator. Such indication of interest may be regardless of the builder's suitability for the project, although in alternative implementations the indication of interest may be filtered by at least the builder's suitability for the project.

In another potential step, the matchmaking may occur automatically (step 126). For example, if a number of builders have indicated interest in performing building services, once a project creator has enlisted the matchmaking tool to find builders, the first builder who indicated interest may receive priority. Of course, a number of other prioritization rules may be employed. For example, priority may go to friends of the project creator, guild mates of the same, those on the same server, those in the same time zone, those of the same faction, those having at least a given skill level or reputation, those with desired components already made, and any number of other such bases for prioritization.

The matchmaking tool may also employ any of the types of filters noted above to eliminate potential builders of lesser interest to the project creator.

In a social networking solution, the player uses a social network or social networking tool to identify builders. In one implementation, the construction project tool checks the capabilities of the player's friends first and informs the player of matching capabilities and/or sends messages to the friends that match. The player and the identified friends discuss the tasks and confirmed builders are added to the project. If there are still missing components or materials, or identified friends are unavailable to help, the tool checks the next degree outward, reviewing the profiles of friends of the player's friends, and again identifies matches. This process continues outward from the player until builders are found for all the components and materials. The player or tool can guide the selection of players using additional information, such as by applying weights for skill or reputation. Prioritization rules or filtering as described above may be employed in similar ways. In another implementation, a separate social network of builders (or set of connections) is maintained for each player to help identify builders by skills, reputation, price, performance, etc., separate from other social contexts.

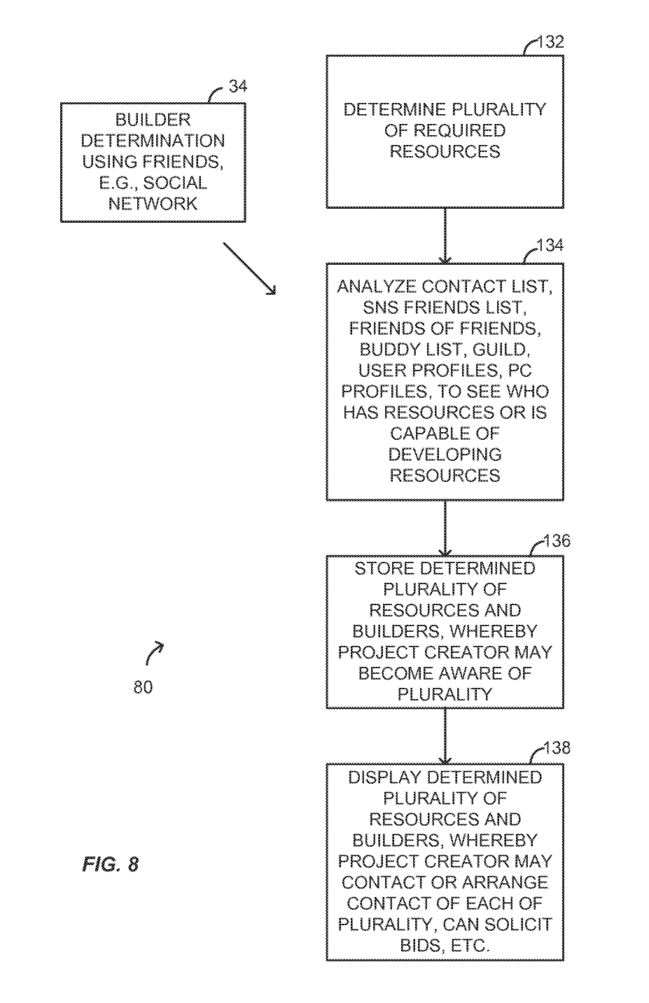

In a particular embodiment, as shown by the flowchart 80 of FIG. 8, the project creator decides to use a social network or social networking tool to determine potential builders (step 34). As before, a first step is to determine a plurality of required resources (step 132). A social network of the project creator is then analyzed to determine who may be potential builders, i.e., who may have resources appropriate to the project. In this analysis, a friends list may be analyzed, friends of the user's friends as described above, and the like. In the same way, the project creator's contact list may be analyzed, as well as a buddy list, a guild list, profiles of player characters in some way associated with the project creator, and the like.

The determined plurality of resources and builders is stored (step 136), such that the project creator may become aware of the determined plurality. The determined plurality may then be displayed to the project creator (step 138). As with a portion of the marketplace solution, the project creator may contact or arrange contact with each member of the plurality, or a subset thereof. The construction project tool may allow for such contact, or the project creator may contact desired builders manually, using, e.g., the electronic communications techniques noted above.

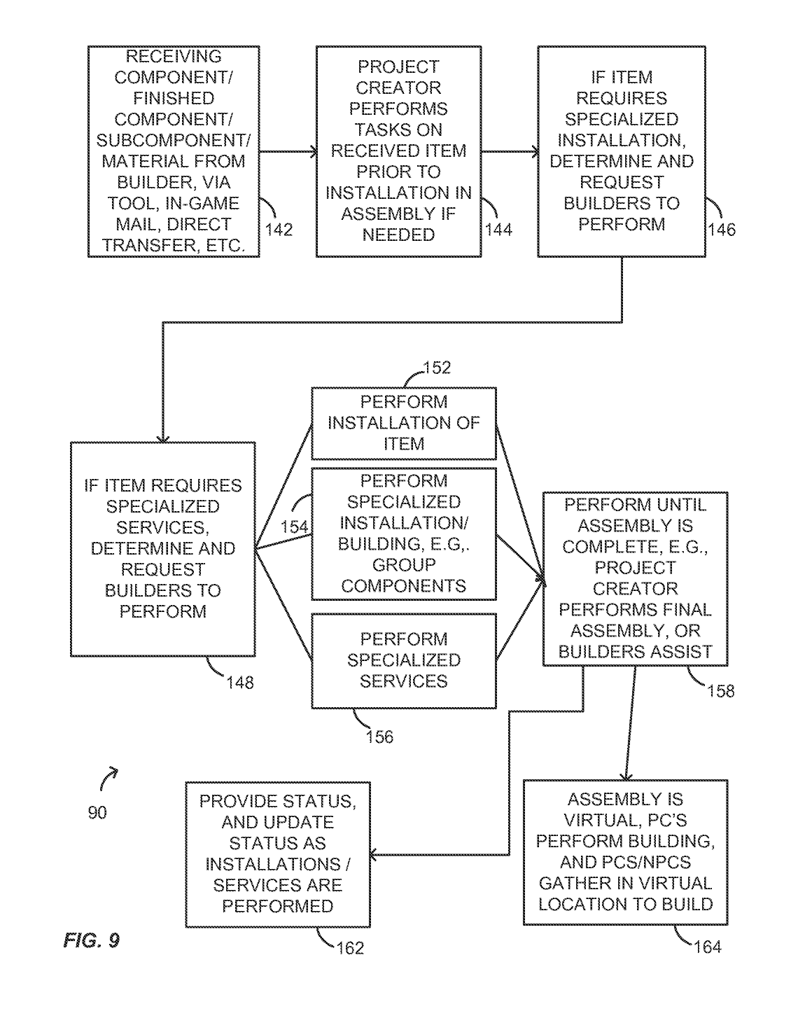

FIG. 9 is a flowchart 90 illustrating a continuing performance of builders constructing an assembly according to a definition according to present principles. In a first step, which is purely exemplary, an element may be received from a builder, either using the construction tool, in-game mail, direct transfer from player character to player character, or the like (step 142). The received element may be a component, a finished component made from subcomponents, materials, sub materials, or the like. It may also be a component or material similar to that received by the builder, but for which the builder performed a service on. For example, in many fantasy multiplayer games, it may be appropriate for a builder to “cast a spell” or the like on a particular component, which generally makes the component or material functionally different than before, prior to sending it on to another builder or to the project creator.

In the next exemplary step, the project creator performs tasks on the received element prior to installation in the assembly, if such tasks are needed (step 144). For example, if the project creator has to paint the item, “cast a spell” thereon, place an imprint denoting the project creator thereon, or perform some other task or service prior to installing the item in the finished assembly, such may be performed during this step.

In the next exemplary step, if an item requires a specialized installation in the assembly, the project creator may determine appropriate builders and request the same to perform the specialized installation (step 146). The determination of builders in this step may be via any of the techniques described above. In the same way, in a next exemplary step, if an item requires specialized services in the assembly, e.g., using special skills, the project creator may determine appropriate builders and request the same to perform the specialized services, and such determination may be as above (step 148).

Several steps may then be performed for installation, depending on how the component, subcomponents, or material has to be installed. If the same can be directly and simply installed, e.g., by the project creator, or by a player character or device under the project creator's direction, then such installation may be performed (step 152). If a specialized installation or building is required, then the same may be performed (step 154). Group components may be installed during this step. If other specialized services are required for installation, then the same may be performed at this time (step 156).

The installation steps may be performed until the assembly is complete (step 158). That is, until the project creator and/or builders have installed all the components and materials, or performed any required services, e.g., using appropriate skills. A complete assembly will generally meet the requirements of the definition, or include, as finished and installed, all the resources listed as required by the definition.

In some cases, a user interface of the construction tool may note the ongoing status of the construction, e.g., as a percentage of completion, and may update the status as installations of components or materials and services are performed (step 162).

In the case of an online multiplayer game, where the digital object is a virtual object in the simulated world, player characters may perform the building, and player characters or nonplayer characters may gather in a virtual location to build a virtual object, e.g., a castle (step 164). It is understood that the common virtual location generally represents a location in the online environment with some virtual extent, e.g., enough virtual extent in which to build a castle. So while player characters and nonplayer characters may congregate at a common location, they do not need to be at exactly the same virtual point.

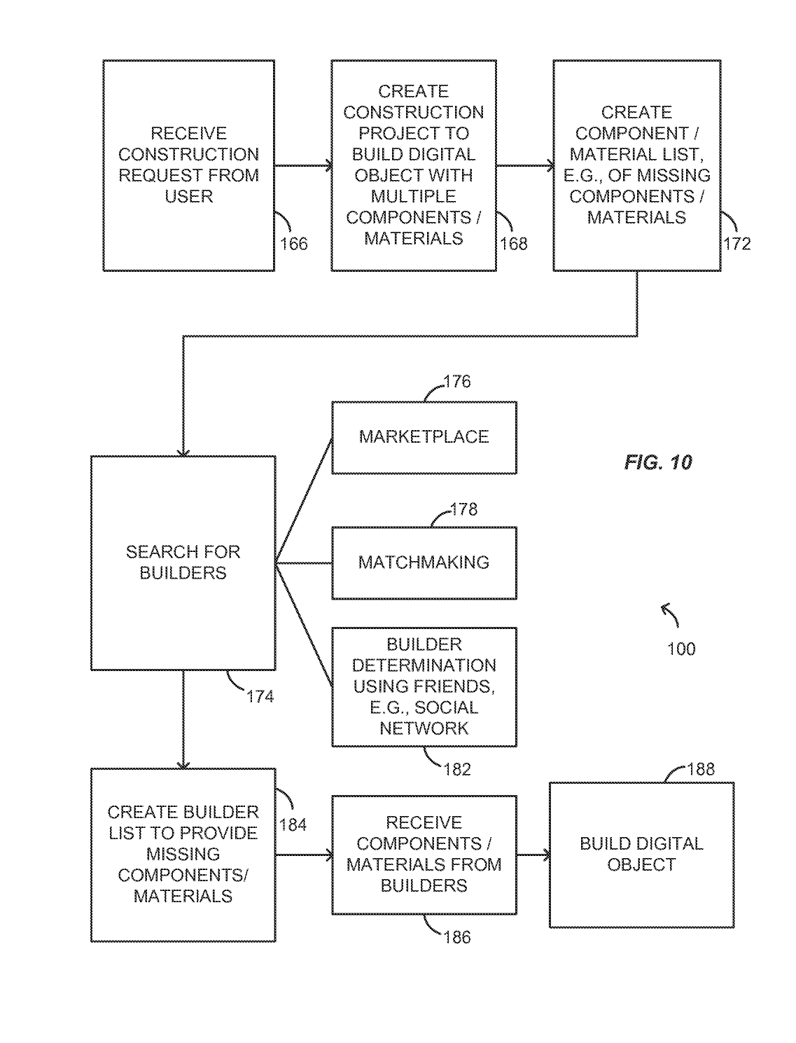

Another implementation according to present principles is shown by the flowchart 100 of FIG. 10. In a first step, a construction request is received from a user (step 166). Generally, the construction request is received by a server implementing a construction project tool. The construction project tool then creates a construction project according to the request, where the construction project is to build a digital object with multiple components and/or materials (step 168). The construction project tool that creates a components and/or materials list (step 172). The component and/or materials list may be of missing components or materials, in the case where the user already has some of the components and/or materials, or is intending to make or gather the same themselves.

The construction project tool may then search for builders (step 174). The result of the search by the construction project tool is then to create a list of builders to provide the missing components and/or materials (step 184). The builder determination may be via a number of methods, as described above, including by the marketplace tool (step 176), by matchmaking using a matchmaking tool (step 178), or by builder determination using friends such as via a social networking tool (step 182). The builders create the required components and/or materials, and the same are received by the project creator (step 186). The digital object may then be built, e.g., by the project creator and/or one or more builders (step 188).

A project creator may determine a deadline and a price to pay for each item in the list of required resources, e.g., flat or percentage. The player can set the deadlines and prices manually, or accept default or automated deadlines and prices provided by the construction project tool, e.g., deadlines based on component dependencies and prices derived from current marketplace or auction prices. In another implementation, the prices are set through a bidding process for potential builders indicating their acceptable time and price and the project creator selects builders, e.g., informed by their bid, builder profile, reputation, and references. However determined, the prices will be paid to the builders when the builders complete their tasks, e.g., if on time. Alternatively, the prices can be paid when the final object is completed or sold.

In an implementation of a method for setting project completion deadlines according to present principles, as indicated by the flowchart 110 of FIG. 11 (A), a project creator may set a deadline and an optional tolerance (step 167). For example, a project creator may desire a project finished in one week, plus or minus two days. Alternatively, the construction project tool may provide a default deadline. Even where a project creator sets the deadline, the construction tool may play a role in suggesting a deadline or a modification of a project-creator-set deadline based on the availability of components, subcomponents, materials, labor, as well as other resources (step 169). Or the construction tool may suggest a deadline, and the user or project creator may modify the deadline accordingly. In any case, once the steps of construction are completed, and the assembly is complete according to the definition, payment may be made (step 171). Payment may be adjusted if necessary to take account of lateness, superior workmanship, or the like.

In an implementation of a method for setting project budgets according to present principles, as indicated by the flowchart 120 of FIG. 11 (B), a project creator may determine a budget, optionally using the construction tool, or may use a default budget for a given type of project (step 173). In the same way as with FIG. 11 (A), the construction tool may suggest a budget, or modifications to a budget, based on market prices of components, materials, labor, or other resources (step 175). In some cases, the construction tool will suggest a budget, and the project creator or user will modify the budget according to their own needs. As above, following completion, payment may be made and adjusted if necessary (step 177).

As illustrated in FIG. 11 (C), in a marketplace solution, builders may bid to provide an entire assembly or components thereof. Such a bidding process may also be employed in matchmaking or social networking solutions (step 175). Bidding may in many cases allow the project creator to obtain the best price for a given project.

In many implementations, builders build components and gather materials on their own and provide the components and materials to the player running the project independently. In another implementation, as mentioned above, the builders gather together to build components at a defined location. For example, in a project to build a castle, the builders may gather to the site of the castle construction to build their components. For components, the builders will come to the same virtual location, collect the components, and then work together to complete the group components. In the castle example, each castle wall may be a group component requiring multiple civil engineer builders and many laborer builders to work together to assemble stone blocks to form the wall. The building sites can be in the open world, visible to all players, or separated, e.g., instanced content.

In another implementation, one or more of the components are custom components. The player can define the general parameters or desired features of the custom component and then try to find builders who can build the custom component using one of the above solutions. A bidding or proposal solution, e.g., part of a marketplace tool and illustrated in FIG. 11(C), may have advantages for complicated components. In another approach, a project creator searches for potential builders for a component and offers the job to a desirable candidate. The project creator can identify a potential builder using reputation or information about created objects, or may use social networking. For example, the project creator may search among the project creator's friends for another user that had a similar component or object built and may open a discussion with that user about the source of the component or object. If none of the player's friends provide a successful candidate, the player can search among friends of the player's friends, and so on. In one implementation, the objects can be created using an implementation of technology disclosed in U.S. patent applications filed on even date herewith, entitled “SYSTEM AND METHOD FOR USER CREATION OF DIGITAL OBJECTS” and “SYSTEM AND METHOD FOR BUILDING DIGITAL OBJECTS WITH BLOCKS”, owned by the assignee of the present application and herein incorporated by reference in their entireties.

In another implementation, in addition to or instead of users or players creating projects to build objects, a public work system creates projects. In a game implementation, a government creates a project to complete and seeks builders to provide components and materials. Alternatively, private entities in the game can also create projects for players. Players looking for work or builders can find these tasks through a marketplace or a matchmaking tool. Players can also find jobs as periodic tasks provided by nonplayer characters, e.g., “daily” quests or tasks (as noted above with respect to step 33 of flowchart 20 in FIG. 2).

The resulting objects may be visible in the game environment permanently, temporarily, or not at all. Alternatively, the completed objects may be visible only to some players, such as to the players who were builders and to their friends. Similarly, a public works project can be open to all players in the open world, or can be separated, e.g., instanced content. In one implementation, public works projects are generated or opened as a result of game events or player actions. For example, a monster raid on a town may cause damage that later needs to be repaired. Tax and public funding, and assessment models, can be used to determine when public works projects will or can be created. In another implementation, public works projects are presented as challenging content requiring coordination of many players to build very complicated or large objects, such as a power station or a dam.

One implementation includes one or more programmable processors and corresponding computer system components to store and execute computer instructions and data, such as to provide the structures, systems, and interfaces to seek and find builders to join a construction project, to manage the project, and to build the digital objects, as well as to provide the construction project tool, marketplace tool, social networking tool, and matchmaking tool described above. One such computing environment is disclosed below.

Additional variations and implementations are also possible. The systems and techniques described above are not limited to the examples described. For example, while discussed in the context of games and simulations, other implementations can include other contexts such as online environments, social networking, communications, or mobile platforms. In one such example, a user creates a project to create a catered luncheon and needs a list of food items prepared and provided. Shops and individuals can be identified and may participate as “builders” to complete the project. While the term “builder” has been employed above to indicate those who are performing skills or providing services, or components or materials, to a project creator, it will be understood that certain builders may act as general contractors, and thus organize others to provide services or components. Lack of performance, once selected as a builder, may cause a player to be subject to various contractual penalties, e.g., fines, specific performance, etc. Conversely, if project creator funds are not verified and automatically deducted from, for payment to builders, and if a project creator is late on payment, contractual penalties may also inure. Project creators may be the subject of reviews, recommendations, and ratings, just as builders are. Other group tasks within online environments may be organized using the construction project tool, e.g., battlegrounds, raids, and the like. Other variations are also possible and will be readily apparent to those of skill in the art in light of this new disclosure.

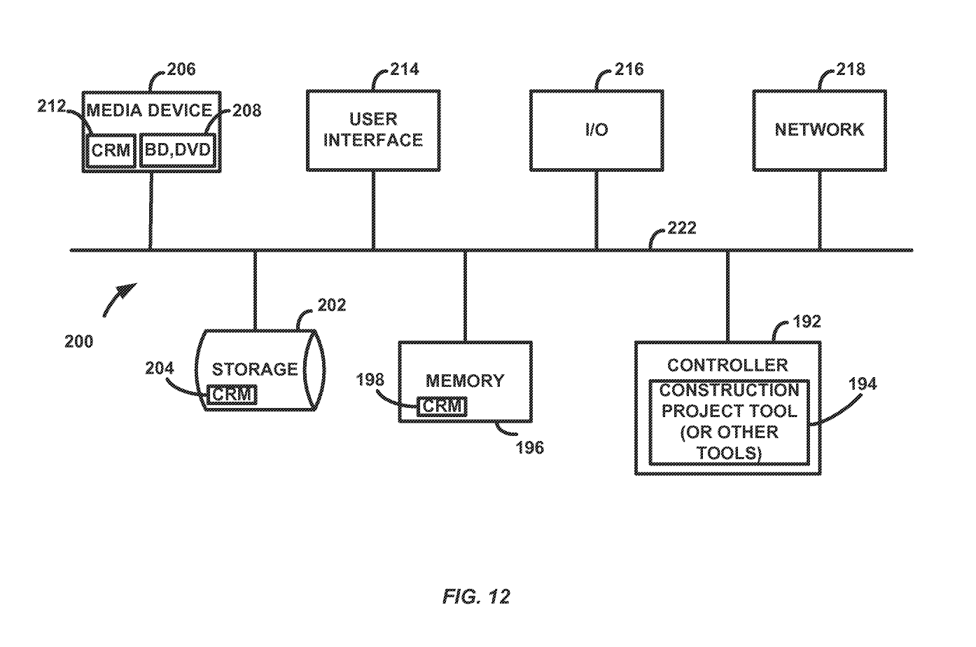

Referring to FIG. 12, a representation of an exemplary computing environment 200 in which the system and method may be implemented is illustrated.

The computing environment 200 includes a controller 192, a memory 196, storage 202, a media device 206, a user interface 214, an input/output (I/O) interface 216, and a network interface 218. The components are interconnected by a common bus 222. Alternatively, different connection configurations can be used, such as a star pattern with the controller at the center.

The controller 192 includes a programmable processor and controls the operation of a construction project tool 194. The controller 192 loads instructions from the memory 196 or an embedded controller memory (not shown) and executes these instructions to control the system.

Memory 196, which may include non-transitory computer-readable memory 198, stores data temporarily for use by the other components of the system. In one implementation, the memory 196 is implemented as DRAM. In other implementations, the memory 196 also includes long-term or permanent memory, such as flash memory and/or ROM.

Storage 202, which may include non-transitory computer-readable memory 204, stores data temporarily or long-term for use by other components of the system, such as for storing data or instructions. In one implementation, the storage 202 is a hard disc drive or a solid state drive.

The media device 206, which may include non-transitory computer-readable memory 212, receives removable media and reads and/or writes data to the inserted media. In one implementation, the media device 206 is an optical disc drive or disc burner, e.g., a writable Blu-Ray® disc drive 208.

The user interface 214 includes components for accepting user input, e.g., the user indication of digital objects or other aspects discussed above, and presenting a display, e.g., of a partially-constructed digital object or a list of required resources or builders, to the user. In one implementation, the user interface 214 includes a keyboard, a mouse, audio speakers, and a display. The controller 192 uses input from the user to adjust the operation of the computing environment.

The I/O interface 216 includes one or more I/O ports to connect to corresponding I/O devices, such as external storage or supplemental devices, e.g., a printer or a PDA. In one implementation, the ports of the I/O interface 216 include ports such as: USB ports, PCMCIA ports, serial ports, and/or parallel ports. In another implementation, the I/O interface 216 includes a wireless interface for wireless communication with external devices. These I/O interfaces may be employed to connect to one or more content playback devices.

The network interface 218 allows connections with the local network and includes a wired and/or wireless network connection, such as an RJ-45 or Ethernet connection or “Wi-Fi” interface (802.11). Numerous other types of network connections will be understood to be possible, including WiMax, 3G or 4G, 802.15 protocols, 802.16 protocols, satellite, Bluetooth®, or the like.

The system may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

The methods shown and described above may be implemented in one or more general, multi-purpose, or single-purpose processors. Unless specifically stated, the methods described herein are not constrained to a particular order or sequence. In addition, some of the described methods or elements thereof can occur or be performed concurrently.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof.

It will be appreciated that particular configurations of the operating environment may include fewer, more, or different components or functions than those described. In addition, functional components of the operating environment may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

1. A method of organizing a plurality of builders to build an assembly, comprising:
A. receiving a definition from a project creator, the definition pertaining to an assembly;
B. from the received definition, determining a plurality of resources required to build the assembly;
C. using the determined resources, determining a plurality of builders having one or more of the plurality of resources required to build the assembly, or capable of making one or more of the plurality of resources required to build the assembly; and
D. storing the determined plurality of builders, whereby the project creator may become aware of the determined plurality.

2. The method of claim 1, wherein the assembly is a virtual assembly, and wherein the determining a plurality of builders capable of making one or more of the plurality of resources further comprises determining a plurality of builders associated with player characters, wherein the player characters have one or more resources required to build the virtual assembly, or are capable of making one or more of the plurality of resources required to build the virtual assembly, wherein a player character is capable of making one or more of the plurality if the player character is associated with skills required to make the one or more of the plurality.

3. The method of claim 1, wherein the receiving a definition includes receiving a custom construction plan including a set of proposed resources or components or both, and wherein the determining a plurality of resources includes matching proposed resources or components with certain of a set of available resources.

4. The method of claim 1, wherein the receiving a definition includes receiving requirements of a desired assembly, and wherein the determining a plurality of resources includes determining a plurality of resources necessary to meet the requirements.

5. The method of claim 1, wherein the receiving a definition includes receiving a selection of an object from a menu, and wherein the determining a plurality of resources includes determining a plurality of resources necessary to create an assembly corresponding to the selected object.

6. The method of claim 5, wherein the receiving a definition further includes receiving a customization option of the object, and wherein the determining a plurality of resources further includes determining a plurality of resources necessary to create or perform a customization option of the assembly to correspond to the customization option of the object.

7. The method of claim 1, wherein the assembly is a CG object or a software application.

8. The method of claim 1, further comprising filtering the determined builders based on one or more criteria, wherein the criteria include one or more selected from the group consisting of: rating, skills, reputation, social network status with respect to the project creator, average online time, faction, and server.

9. The method of claim 1, wherein the determining a plurality of builders includes analyzing a contacts list of the project creator and player characters associated therewith, a social networking friends list of the project creator and player characters associated therewith, a buddy list of the project creator and player characters associated therewith, a members list of a guild associated with the project creator or with a player character controlled by the project creator, profiles of members of an online community and player characters associated therewith, profiles of a group or company of builders indicating a desired for cooperative building.

10. The method of claim 1, wherein one of the plurality of resources is a custom component, and further comprising displaying a request for proposals for the custom component, along with at least one requirement of the custom component.

11. The method of claim 1, wherein resources are one or more selected from the group consisting of: components, materials, subcomponents required to build components, materials required to build components or subcomponents, services required to obtain components or subcomponents or materials, services required to make components or subcomponents or materials, or services required to construct at least a portion of an assembly from components or materials or both.

12. A non-transitory computer readable medium, comprising instructions for causing a computing environment to perform the method of claim 1.

13. A method of organizing a plurality of builders to build an assembly, comprising:
A. receiving a definition from a project creator, the definition pertaining to an assembly;
B. from the received definition, determining a plurality of resources required to build the assembly; and
C. publishing a list of one or more of the plurality of resources in a location accessible to a community, and receiving responses to the published list from builders indicating interest in providing one or more of the plurality of resources.

14. The method of claim 13, further comprising displaying builders from which responses have been received, and further comprising filtering the displayed based on one or more criteria, wherein the criteria include one or more selected from the group consisting of: rating, skills, reputation, social network status with respect to the project creator, average online time, faction, and server.

15. The method of claim 13, wherein resources are one or more selected from the group consisting of: components, materials, subcomponents required to build components, materials required to build components or subcomponents, services required to obtain components or subcomponents or materials, services required to make components or subcomponents or materials, or services required to construct at least a portion of an assembly from components or materials or both.

16. A non-transitory computer readable medium, comprising instructions for causing a computing environment to perform the method of claim 13.

17. A method of organizing a plurality of builders to build an assembly, comprising:
A. receiving a definition from a project creator, the definition pertaining to an assembly;
B. from the received definition, determining a plurality of resources required to build the assembly; and
C. matching one or more builders indicating interest in building with one or more of the plurality of resources corresponding to an assembly.

18. The method of claim 17, further comprising transmitting a notification to a builder indicating that the builder is hired to provide the one or more of the plurality of resources.

19. The method of claim 17, further comprising automatically matching builders to the assembly, according to which builder first indicated interest in one or more of the plurality of resources.

20. The method of claim 19, further comprising filtering the builders to be matched based on one or more criteria, wherein the criteria include one or more selected from the group consisting of: rating, skills, reputation, social network status with respect to the project creator, average online time, faction, and server.

21. The method of claim 17, wherein resources are one or more selected from the group consisting of: components, materials, subcomponents required to build components, materials required to build components or subcomponents, services required to obtain components or subcomponents or materials, services required to make components or subcomponents or materials, or services required to construct at least a portion of an assembly from components or materials or both.

22. A non-transitory computer readable medium, comprising instructions for causing a computing environment to perform the method of claim 17.

23. A method of building an assembly using a plurality of builders, the assembly having a definition provided by a project creator, the assembly having multiple components, comprising:
A. receiving a finished component from a builder, and installing the finished component in an assembly according to a definition;
B. if a finished component requires a specialized installation, determining one or more builders capable of performing the specialized installation, and sending a request to the determined one or more builders to perform the specialized installation;
C. if a component requires specialized services, determining one or more builders capable of performing the specialized services, and sending a request to the determined one or more builders to perform the specialized services; and
D. performing the installing, the specialized installations as needed, and the specialized services as needed, until all components in the assembly are installed according to the definition.

24. The method of claim 23, further comprising displaying a status indicating a state of completion of the assembly, and upon each installation, specialized installation, or service, updating the status.

25. The method of claim 23, wherein the one or more builders perform the specialized installation in collaboration with the project creator.

26. The method of claim 23, wherein the assembly is a virtual assembly and is associated with an online simulation, and wherein a player character associated with the project creator and player characters associated with respective ones of at least a subset of builders providing components or services congregate at a common virtual location within the online simulation to perform a building of the virtual assembly.

27. A non-transitory computer readable medium, comprising instructions for causing a computing environment to perform the method of claim 23.

28. A method for creating digital objects, comprising:
A. receiving a construction request from a requesting user;
B. creating a construction project to build a digital object, where the digital object includes multiple components;
C. creating a component list of missing components needed to complete the digital objects;
D. searching for users to provide the missing components;
E. creating a builder list of users identified to provide missing components;
F. receiving components from users; and
G. when all the missing components have been received, building the digital object.

29. The method of claim 28, wherein the searching for users to provide missing components includes placing a component request on a marketplace service.

30. The method of claim 28, wherein the searching for users to provide missing components includes using a matchmaking tool that compares skills required to build components and skills of available users.

31. The method of claim 28, wherein the searching for users to provide missing components includes using a social network to identify users by their relationship to the requesting user.
